(19) United States
(12) Patent Application Publication
(10) Pub. No.: US 2005/0288926 A1
(43) Pub. Date: Dec. 29, 2005

(54) Network support for wireless e-mail using speech-to-text conversion

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 10/877,603

(22) Filed: Jun. 25, 2004

(51) Int. Cl. G10L 15/26

(52) U.S. Cl. 704/235

(57) ABSTRACT

Embodiments of the system, and method provide for network support for wireless e-mail using speech-to-text conversion. One embodiment of the method may have the steps of: entering a spoken message at the mobile terminal; sending the spoken message to the network; and converting, at the network, the spoken message to an e-mail message that is sendable to any e-mail address.

### TECHNICAL FIELD

The present invention relates generally to wireless telecommunication, and in particular to sending wireless e-mail using speech-to-text conversion technologies.

### BACKGROUND OF THE INVENTION

Wireless communication systems are constantly evolving. System designers are continually developing greater numbers of features for both service providers as well as for the end users. In the area of wireless phone systems, cellular based phone systems have advanced tremendously in recent years. Wireless phone systems are available based on a variety of modulation techniques and are capable of using a number of allocated frequency bands. Available modulation schemes include analog FM and digital modulation schemes using Time Division Multiple Access (TDMA) or Code Division Multiple Access (CDMA). Each scheme has inherent advantages and disadvantages relating to system architecture, frequency reuse, and communications quality. However, the features the manufacturer offers to the service provider and which the service provider offers to the consumer are similar between the different wireless systems.

Regardless of the modulation scheme in use, the wireless phone available to the end user has a number of important features. Nearly all wireless phones incorporate at least a keyboard for entering numbers and text, and a display that allows the user to display text, dialed numbers, pictures and incoming caller numbers. Additionally, wireless phones may incorporate electronic phonebooks, speed dialing, single button voicemail access, and messaging capabilities, such as e-mail.

The features described above present only a sample of features that are capable of, or have already been, implemented into wireless phone systems. Any individual feature is capable of implementation into some or all of the wireless systems using the modulation schemes mentioned above. A particularly useful feature provides messaging capability within phones. The Short Message Services (SMS) feature used in a CDMA wireless communication system allows for information transfer to and from a wireless phone. However, the implementation of SMS is not limited to use in a CDMA system. The description of SMS in a CDMA system is merely provided as a foundation for the discussion of the preferred embodiment of the invention presented below. Short Message Services (SMS) are used to allow the communication of alphanumeric messages to wireless phones. As is well known in the art, a human must typically key in a SMS message.

In today's world e-mailing is becoming an ever-more popular way to communicate. Many people, however, find the entry of e-mail messages on mobile handset keypads to be very cumbersome, time-consuming, and not practical to do while driving or walking, for example.

Thus, while it is possible to send e-mail from many wireless phones to any e-mail address, it is very cumbersome to type text on a mobile handset using the numerical keypad. It is therefore a drawback of the prior art that the use of e-mail on wireless phones is very limited by the required use of the keypad.

### SUMMARY

The invention in one implementation encompasses a system. One embodiment of the system may have: a network operatively connected to at least one mobile terminal. As is known the network may have at least one base station, which is operatively connected to a mobile switching center, wirelessly coupled to the mobile terminal. The mobile switching center in the network may also have a call control module operatively connected to base station and to a speech/text conversion module. A memory may also be operatively connected to the speech/text conversion module.

Another implementation of the present invention encompasses a method that may have the steps of: entering a spoken message at the mobile terminal; sending the spoken message to the network; and converting, at the network, the spoken message to an e-mail message that is sendable to any e-mail address.

### BRIEF DESCRIPTION OF THE DRAWINGS

Features of exemplary implementations of the invention will become apparent from the description, the claims, and the accompanying drawings in which:

FIG. 1 depicts a block diagram that illustrates elements of a system according to one embodiment for sending wireless e-mail using speech-to-text conversion technologies.

FIG. 2 illustrates a very general flow chart of logical operational steps that may be followed in accordance with one embodiment of the present method and system.

FIG. 3 illustrates a more detailed flow chart of logical operational steps that may be followed in accordance with one embodiment of the present method and system.

FIG. 4 illustrates a another flow chart of logical operational steps that may be followed in accordance with one embodiment of the present method and system.

### DETAILED DESCRIPTION

The particular values and configurations discussed in these non-limiting examples can be varied and are cited merely to illustrate an embodiment of the present invention and are not intended to limit the scope of the invention.

Embodiments of the present system and method may provide for network support for wireless e-mail using speech-to-text conversion. One embodiment of the method may have the steps of: entering a spoken message at the mobile terminal; sending the spoken message to the network; and converting, at the network, the spoken message to an e-mail message that is sendable to any e-mail address. A further embodiment may have the additional steps of: converting, at the network, a text message in the selected e-mail to a spoken message; sending the spoken message to the mobile terminal; and playing the spoken message at the mobile terminal.

Although the present system and method may be used with any type of network (wired and wireless, for example), a subscriber may typically be a mobile subscriber who uses a mobile terminal (also referred to as mobile phone, a cell phone, mobile handset, or car phone).

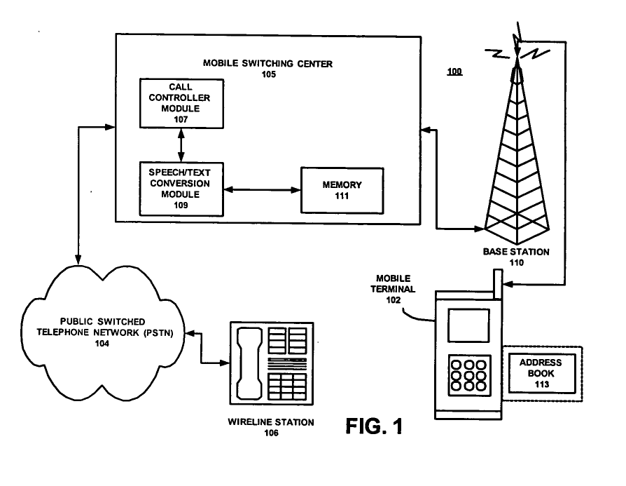

In the FIG. 1 embodiment a network 101 is operatively connected to at least one mobile terminal 102. As is known the network 101 may have at least one base station 103, which is operatively connected to a mobile switching center 105, wirelessly coupled to the mobile terminal 102. The mobile switching center 105 in the network 101 may also have a call control module 107 operatively connected to base station 103 and to a speech/text conversion module 109. A memory 111 may also be operatively connected to the speech/text conversion module 109.

The network 101 may be, or may be part of, one or more of a telephone network, a local area network (“LAN”), the Internet, and a wireless network. In the depicted embodiment, a public switched telephone network (PSTN) 104 is connected to the mobile switching center 105. The PSTN 104 routes calls to and from mobile users through the mobile switching center 102. The PSTN 104 also routes calls from and to wireline stations 106. The PSTN 104 generally may be implemented as the worldwide voice telephone network accessible to all those with telephones and access privileges (e.g., AT&T long distance network).

Upon entering a spoken message at the mobile terminal 102, the spoken message is sent to the mobile switching center 105 via the base station 103. The network 101 converts the spoken message to an e-mail that is sendable to any e-mail address.

A command (voice, text, or predetermined key stroke, for example) may be entered at the mobile terminal 102 instructing the mobile terminal 102 to create an e-mail message wherein a connection is established from the mobile terminal 102 to the network 101. The spoken message that then is entered at the mobile terminal 102 and the spoken message in sent to the network 101. The speech/text conversion module 109 converts the spoken message to a text message, which may be stored in the memory 111.

In order to send the e-mail to a recipient, an identity of at least one recipient of the text message is entered at the mobile terminal 102. At least one e-mail address respectively corresponding to the at least one recipient may be determined at the mobile terminal 102 and the e-mail address may be sent to the network 101. The mobile terminal 102 may have at least one e-mail address of the at least one recipient stored in an electronic address book 113 in the mobile terminal 102. The e-mail may then be formed by the network 101 from the text message and the at least one e-mail address. The network 101 may then send the e-mail to the at least one recipient.

In one embodiment, upon completion of the spoken message, an end of message command is entered at the mobile terminal 102 and sent to the network 101.

For receiving e-mails at the mobile terminal 102, a text message that is stored in the memory 111 is converted to a spoken message upon receiving a request for e-mail from the mobile terminal 102, and a signal may be sent to the mobile terminal 102, the signal indicating that at least one e-mail has arrived for the user of the mobile terminal 102. Upon receiving a request for e-mail from the mobile terminal 102, operation of the network 101 may then proceeds as follows: selecting, at the network 101, e-mail having an e-mail address that corresponds to the mobile terminal 102 and sending the selected e-mail to the mobile terminal 102.

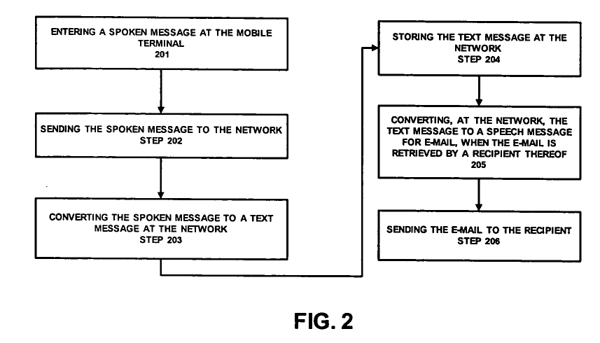

Referring to FIG. 2, one embodiment of a method for network support for wireless e-mail using speech-to-text conversion, may have the steps of: entering a spoken message at the mobile terminal (step 201); sending the spoken message to the network (step 202); converting the spoken message to a text message at the network (step 203); storing the text message at the network (step 204); converting, at the network, the text message to a speech message for e-mail, when the e-mail is retrieved by a recipient thereof (205); and sending the e-mail to the recipient (step 206).

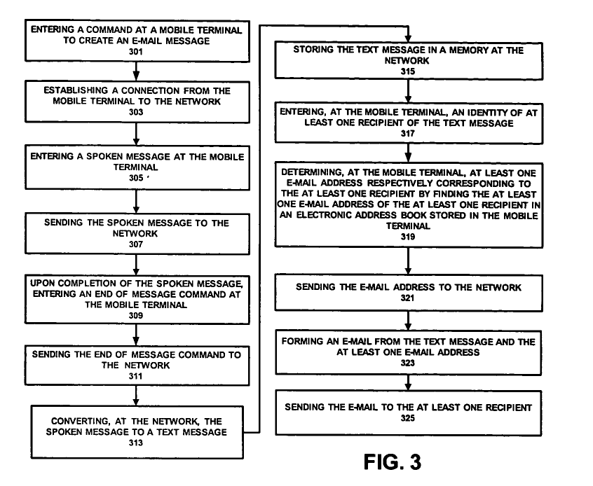

FIG. 3 is a block diagram depicting another embodiment of the present method. This embodiment of the method may have the steps of: entering a command at a mobile terminal to create an e-mail message (step 301); establishing a connection from the mobile terminal to the network (step 303); entering a spoken message at the mobile terminal (step 305); sending the spoken message to the network (step 307); upon completion of the spoken message, entering an end of message command at the mobile terminal (step 309); sending the end of message command to the network (step 311); converting, at the network, the spoken message to a text message (step 313); storing the text message in a memory at the network (step 315); entering, at the mobile terminal, an identity of at least one recipient of the text message (step 317); determining, at the mobile terminal, at least one e-mail address respectively corresponding to the at least one recipient by finding the at least one e-mail address of the at least one recipient in an electronic address book stored in the mobile terminal (step 319); sending the e-mail address to the network (step 321); forming an e-mail from the text message and the at least one e-mail address (step 323); and sending the e-mail to the at least one recipient (step 325).

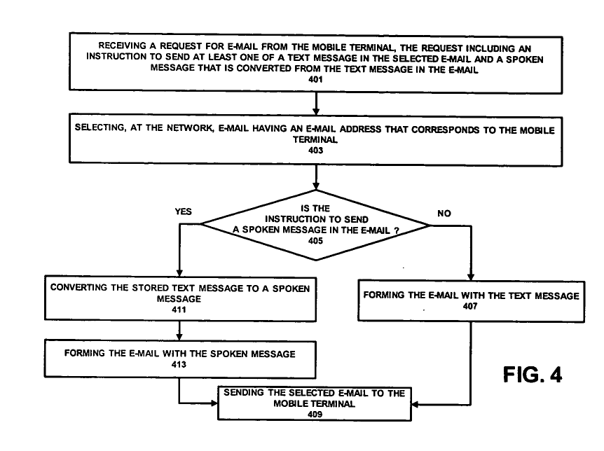

FIG. 4 is a block diagram depicting another embodiment of the present method. This embodiment of the method may have the steps of: receiving a request .for e-mail from the mobile terminal, the request including an instruction to send at least one of a text message in the selected e-mail and a spoken message that is converted from the text message in the e-mail (step 401); selecting, at the network, e-mail having an e-mail address that corresponds to the mobile terminal (step 403); if the instruction is to send a text message in the selected e-mail (step 405), forming the e-mail with the text message (step 407) and sending the selected e-mail to the mobile terminal (step 409); and if the instruction is to send a spoken message in the e-mail (step 405), converting the stored text message to a spoken message (step 411), forming the e-mail with the spoken message (step 413) and sending the selected e-mail to the mobile terminal (step 409).

Therefore, the improved present method and system overcomes the drawbacks of the prior art, such as, the difficulty of typing text on a mobile handset using the numerical keypad. Embodiments of the present system and method solves the problems in the prior art regarding the use of e-mail on wireless phones being very limited by the required use of the keypad.

The present system and method may be used with non-mobile phones and terminals, as well as, mobile phones and mobile terminals. Also, different types of data storage devices may be used with the present method and system. For example, a data storage device may be one or more of a magnetic, electrical, optical, biological, and atomic data storage medium.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. A method for network support for wireless e-mail using speech-to-text conversion, comprising the steps of:
entering a command at a mobile terminal to create an e-mail message;
establishing a connection from the mobile terminal to the network;
entering a spoken message at the mobile terminal;
sending the spoken message to the network;
converting, at the network, the spoken message to a text message;
entering, at the mobile terminal, an identity of at least one recipient of the text message;
determining, at the mobile terminal, at least one e-mail address respectively corresponding to the at least one recipient;
sending the e-mail address to the network; and
forming an e-mail from the text message and the at least one e-mail address.

2. The method according to claim 1, wherein the method further comprises: sending the e-mail to the at least one recipient.

3. The method according to claim 1, wherein the method further comprises: storing the text message in a memory at the network.

4. The method according to claim 1, wherein the method further comprises: upon completion of the spoken message, entering an end of message command at the mobile terminal; and sending the end of message command to the network.

5. The method according to claim 1, wherein the method further comprises, in the step of determining, at the mobile terminal, at least one e-mail address respectively corresponding to the at least one recipient: finding the at least one e-mail address of the at least one recipient in an electronic address book stored in the mobile terminal.

6. The method according to claim 1, wherein the method further comprises:
receiving, at the network, an e-mail for a user of the mobile terminal;
receiving a request for e-mail from the mobile terminal;
selecting, at the network, e-mail having an e-mail address that corresponds to the mobile terminal; and
sending the selected e-mail to the mobile terminal converting, at the network, a text message in the selected e-mail to a spoken message; and
sending the spoken message to the mobile terminal.

7. The method according to claim 6, wherein the request includes an instruction to send at least one of a text message in the selected e-mail and a spoken message that is converted from the text message in the e-mail.

8. The method according to claim 6, wherein the method further comprises:
converting, at the network, a text message in the selected e-mail to a spoken message;
sending the spoken message to the mobile terminal; and
playing the spoken message at the mobile terminal.

9. The method according to claim 6, wherein the method further comprises: sending from the network to the mobile terminal a signal that indicates that at least one e-mail has arrived for the user of the mobile terminal.

10. The method according to claim 6, wherein the method further comprises:
receiving a voice command at the mobile terminal to one of delete the e-mail and save the e-mail;
sending the command from the mobile terminal to the network; and
in response to the command respectively one of deleting and saving the e-mail at the network.

11. A method for network support for wireless e-mail using speech-to-text conversion, comprising the steps of:
entering a spoken message at the mobile terminal;
sending the spoken message to the network; and
converting, at the network, the spoken message to an e-mail message that is sendable to any e-mail address.

12. The method according to claim 11, wherein the spoken message is converted to a text message at the network and stored at the network; and wherein the method further comprises converting, at the network, the text message to a speech message for the e-mail, when the e-mail is retrieved by a recipient thereof.

13. A system for providing network support for wireless e-mail using speech-to-text conversion, comprising:
a network operatively connected to at least one mobile terminal;
the network having:
a call control module operatively connected to the at least one mobile terminal;
a speech/text conversion module operatively connected to the call control module; and
a memory operatively connected to the speech/text conversion module;
wherein upon entering a spoken message at the mobile terminal, and sending the spoken message to the network, the network converts the spoken message to an e-mail that is sendable to any e-mail address.

14. The system according to claim 13, wherein the system further comprises:
a command that is entered at a mobile terminal instructing the mobile terminal to create an e-mail message wherein a connection is established from the mobile terminal to the network;
a spoken message that is entered at the mobile terminal wherein the spoken message in sent to the network;
a text message that is converted from the spoken message at the network;
an identity of at least one recipient of the text message that is entered at the mobile terminal wherein at least one e-mail address respectively corresponding to the at least one recipient is determined at the mobile terminal and wherein the e-mail address is sent to the network; and
an e-mail formed by the network from the text message and the at least one e-mail address.

15. The system according to claim 14, wherein the e-mail is sent to the at least one recipient.

16. The system according to claim 14, wherein the text message is stored in the memory at the network.

17. The system according to claim 14, wherein, upon completion of the spoken message, an end of message command is entered at the mobile terminal; and wherein the end of message command is sent to the network.

18. The system according to claim 14, wherein the mobile terminal has at least one e-mail address of the at least one recipient stored in an electronic address book in the mobile terminal.

19. The system according to claim 14, wherein the system further comprises:
an e-mail for a user of the mobile terminal, the e-mail being received at the network;
a request for e-mail received by the network from the mobile terminal;
wherein the network includes selecting, at the network, e-mail having an e-mail address that corresponds to the mobile terminal; sending the selected e-mail to the mobile terminal; converting, at the network, a text message in the selected e-mail to a spoken message; and sending the spoken message to the mobile terminal.

20. The system according to claim 19, wherein, the method further comprises sending a signal is from the network to the mobile terminal, the signal indicating that at least one e-mail has arrived for the user of the mobile terminal.
